(19) United States
(12) Patent Application Publication
(10) Pub. No.: US 2007/0235473 A1
(43) Pub. Date: Oct. 11, 2007

(54) Liquid handling system for reference fuels

(76) Inventors: Randall C. Wade, Magnolia, TX (US); James A. Ramin, Magnolia, TX (US)

Correspondence Address: RANDALL C. WADE, 39019 FM149, MAGNOLIA, TX, 77354, US

(21) Appl. No.: 11/391,856

(22) Filed: Mar. 30, 2006

(51) Int. Cl. B67D 1/16; B67D 1/08; B67D 5/38

(52) U.S. Cl. 222/108; 222/158; 222/152

(57) ABSTRACT

A fluid (liquid) handling system for use in dispensing of liquids or blending solutions by transferal of one or more liquid(s) from original container(s), into volumetric measuring device(s), dispensing measured volume(s), and returning unused liquid(s) back into original container(s), using vacuum (reduced pressure) as means of operation. constituent liquid (fluids) from their original container(s), transferring to volumetric measuring device(s)

### BACKGROUND OF THE INVENTION

1. Field of the Invention

The invention is a liquid handling system used to blend octane, cetane and tetraethyllead fuel standards to be used to determine antiknock and octane ratings of fuels for spark-ignition engines per ASTM Tests D2699, D2700, and D613.

2. Description of Related Art

Manufacturer's of gasoline and diesel fuels must test the anti-knock characteristics and octane ratings of the fuels that they manufacture. This is accomplished universally by all producers who must follow the accepted methods detailed in the above named ASTM Test procedures

Generally, these procedures require the blending of several standard reference fuels such as isooctane, n-heptane, octane blend, and tetraethyllead solution, in prescribed volumes, burning the mixtures in a special spark-ignition engine, noting the readings on the engine knock sensors to determine anti-knock and octane data on these standard mixtures. This data is then used to interpret the anti-knock and octane specifications on newly produced fuels, burned in the test engine under identical conditions.

Typically, the several standard reference fuels mentioned above are packaged in metal containers of approximately 5 gallon capacity, and these contents must be transferred to individual burets which are volumetrically calibrated. This is normally accomplished by using several standard automotive 12 volt DC fuel pumps. When all standard blending fuels have been filled into the several burets, the operator then follows a set formula and dispenses precise volumes of each fuel standard into another container. This mixture is then burned in the test engine to obtain specific data from the sensors, of readings with a known octane blend. This data will be used to determine the octane specifications of new fuel being tested.

Once the known standard fuel blend has been gathered from the several volumetric burets, there is residual fuel standard in each buret which may degrade if left, and produce errors on future test blends. Accordingly, the residual fuels must be manually removed and restored to their respective containers, or discarded. The former is cumbersome and hazardous, and the later is expensive, since the reference fuel standards are extremely expensive.

The present process of testing fuel octane ratings is time-consuming, tedious, dangerous, and expensive. The invention seeks to bring about the following improvements which do not violate any part of the ASTM Test Methods;
Elimination or reduction of explosion hazard where combustible fuels and their vapors, are exposed to sparking from electric current, and
Facilitate return of unused reference fuel standards from the measuring burets to their respective containers, with no degradation of the standard.

### SUMMARY OF THE INVENTION

In accordance with the present invention, the foregoing advantages have been achieved through the System of the present invention which includes valves, fittings, connectors, conduits, volumetric measuring burets, fuel recovery traps, 3-way flow control valves, pressure release manifold, vacuum manifold, vacuum release valve, and necessary hardware, clamps, and support devices. All of these system components are arranged and connected in a unique way to accomplish the stated objective improvements. Electrical components are eliminated, and the movement of liquid fuels is accomplished by the present invention which employs pressure differentials directed through components of the system.

In practice, several parallel stations are arranged employing common Vacuum Pressure Manifolds and Vacuum Release Manifolds. Each station consists of a bulk container of fuel standard, a 3-way Flow Control Valve, a Volumetric Measuring Buret, and a Fuel Recovery Trap interconnected with various fittings and conduits. A remote vacuum source is connected via conduit to the Vacuum Manifold containing several ports which connect vacuum pressure to several parallel stations through Fuel Recovery Traps, to upper ports of Volumetric Measuring Burets.

When the vacuum source is turned on, and the 3-way Flow Control Valve is rotated to the “FILL” position, fuels residing in the bulk containers may be suctioned into the Volumetric Measuring Burets of any or all stations. Each station is operated individually by the 3-way valve for that station, and when fuel in each buret rises to the upper overflow chamber, the valve is turned to the center “STOP” position, vacuum source is turned off, and excess fuel overflowing is collected in the Fuel Recovery Trap.

As the vacuum source is turned off, the Vacuum Release Valve automatically vents the Pressure Release Manifold to atmospheric pressure, and when the 3-way Flow Control Valve is turned to the “DISPENSE” position, a controlled precise volume of reference fuel may be delivered from the delivery tip. In this manner, several parallel stations may be employed to withdraw different reference fuels from their bulk containers into volumetric measuring burets where specific accurate volumes of each fuel may be dispensed to form a solution consisting of a desired fuel blend mixture.

A feature of the present invention is that the process of transferring, measuring, dispensing, and handling of combustible fuels may be accomplished safely with no exposure to ignition from electrical devices.

A further feature of the present invention is that excess fuel used to fill the Volumetric Measuring Burets beyond the overflow point is collected in the Fuel Recovery Traps for convenient transfer back to original bulk containers, so that there is no waste of these expensive standard fuels, and no degradation from exposure outside heir safe containers. Another feature of the present invention is that expensive fuel standards remaining in the burets after volume blending, may be returned directly back to the original bulk containers by simple rotation of the 3-way Flow Control Valves to the “FILL” position, thus avoiding degradation of the light-sensitive fuel standard.

And still another feature of the present invention is the unique operation of the Vacuum Release Valve which is a vital part of the System. For the system to operate properly, the Vacuum Manifold must apply negative pressure to all stations connected to it when the vacuum supply is turned on to fill fuel into the burets.. But after the burets are filled, the Vacuum Release Manifold must be returned to atmospheric pressure so that air will displace liquid volumes being measured and dispensed from the burets. The Vacuum Release Valve accomplishes this purpose. This Valve consists of a moving seal inside a connecting body with a seat, arranged so that when vacuum is applied, the moving seal contacts the seat and prevents any air from entering the system. When the vacuum source is stopped, the moving seal separates from the seat, and allows ambient air to enter the system and return it to atmospheric pressure.

The System of the present invention, when compared to the previously described related art, has the advantage of reducing or eliminating the hazard(s) of transferring combustible motor fuels by deletion of any spark-producing electrical components. An additional advantage is conservation of the expensive fuel standards, and prevention of degradation of these light-sensitive fuels by the ability to withdraw them from the protection of their bulk containers, measure and accurately dispense prescribed volumes, and return the unused volumes back to the containers.

### BRIEF DESCRIPTION OF THE DRAWINGS

In the drawings:

FIG. 1 is a schematic presentation of the System components connected in specific sequence and manner as to accomplish the objectives according to the present invention.

FIG. 2 is a representation of one type of Vacuum Release Valve showing the body, movable seal, and fixed seat.

FIG. 3 is an illustration of the automatic zero configuration at upper end of the Volumetric Measuring Burets, which contributes to the volumetric accuracy, reproducibility, and precision of the fuel blend mixtures using the present invention.

FIG. 4 is a representation of the flow paths of the 3-way Flow Control Valve, when in each of the three positions.

While the invention will be described in connection with the preferred embodiments, it will be understood that it is not intended to limit the invention to those embodiments. On the contrary, it is intended to cover all alternatives, modifications, and equivalents as may be included within the spirit and scope of the invention as defined by the claims.

### DETAILED DESCRIPTION OF THE INVENTION

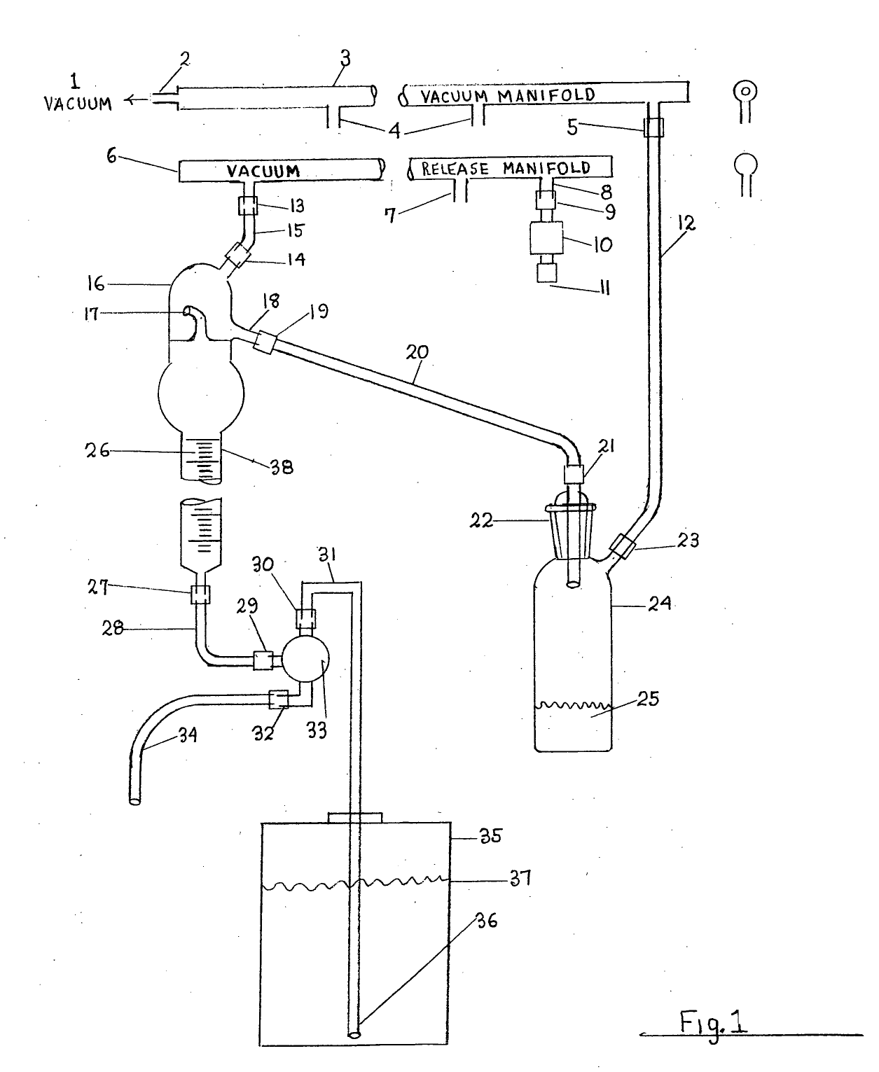

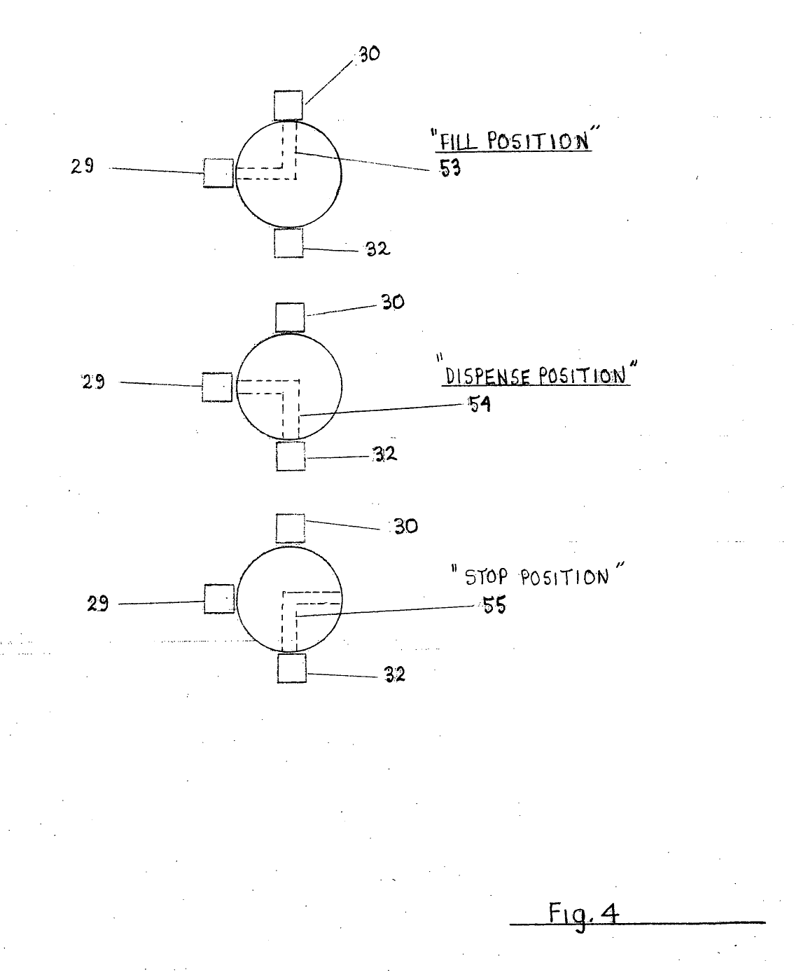

In FIG. 1 a single station of the System which is the present invention is shown with the container of motor fuel standard 35 filled to level 37, in which is inserted from top, a conduit 31 connected on other end to “FILL” port 30 of a 3-way Flow Control Valve 33. Said Flow Control Valve 33 is a 3-position device which may be moved to change flows of liquids as follows: Referring to FIG. 4, the “FILL” position 53 connects valve port 29 with valve port 30 and allows flow from container 35 to lower fitting 27 of Volumetric Measuring Buret 38 through conduit 28 connected at each end with fitting 29 and fitting 27. When the Flow Control Valve 33 is placed in the “DISPENSE” position 54, valve port 29 is connected with valve port 32, allowing flow liquid from Volumetric Measuring Buret 38 through the 3-way valve 33 to delivery tip 34.

Still with reference to FIGS. 1 and 4, when Flow Control Valve 33 is placed in the “FILL” position 53, and vacuum 1 is activated, fuel 37 in Container 35 is caused to flow from bottom to top of the Volumetric Measuring Buret 38, terminating at the automatic overflow tip 17 inside upper chamber 16 of said buret 38, therefore providing a constant “0” (zero) point from which any specified volume may be dispensed when Flow Control Valve 33 is moved to “DISPENSE” position 5. When liquid fuel is filled into the Volumetric Measuring Buret 38 and overflows at top 17 into the overflow chamber 16, the Flow Control Valve 33 is moved to the “STOP” position 55, and excess fuel drains from overflow chamber 16, through exit port 18, connected to conduit 20 with connector 19, and thereafter into the Fuel Recovery Trap 24 connected thereto by connector 21.

Still with reference to FIG. 1, the Fuel Recovery Trap 24 is an in-line device to trap liquid from the automatic zero chamber 16, preventing fuel from entering the Vacuum Manifold 3, and providing temporary safe storage until fuel can be transferred back to original bulk motor fuel container 35. This trap has a removable top 22 for convenience in transferring fuel back to bulk container 35, and is connected on upper end to the Vacuum Manifold 3, via conduit 12 and connectors 23 and 5.

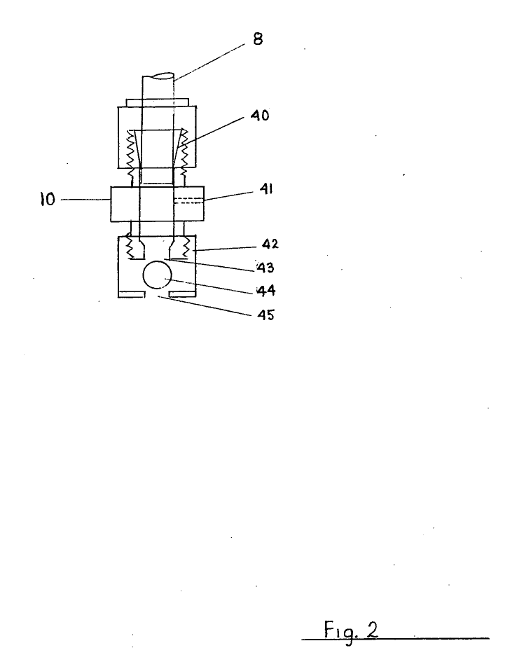

Reference FIGS. 1 and 2, a Vacuum Release Manifold 6 with a Vacuum Release Valve 10 (and FIG. 2) functions in the System as a device to allow each Volumetric Measuring Buret 38 to be vented in the upper automatic zero chamber 16, and system pressure returned from negative (vacuum), to atmospheric, so that contents of the Volumetric Measuring Buret 38 might be released to dispense any specific volume as indicated by calibrations 26 on said buret 38. The Vacuum Release Valve 10 and FIG. 2 consists of a body with upper connection 40 to any port 8 of the Vacuum Release Manifold 6, and a lower movable seal 44 and seat 43, with vented seal retainer 45. A small venting hole 41 is placed in the body of the Vacuum Release Valve 10. of calculated size to enable the lower movable seal 44 to be lifted to seal against seat 43 when vacuum is applied, and to drop downward to vent the system when vacuum is stopped. In this manner, fuel can be filled and dispensed from each Volumetric Measuring Buret(s) 38 in the system.

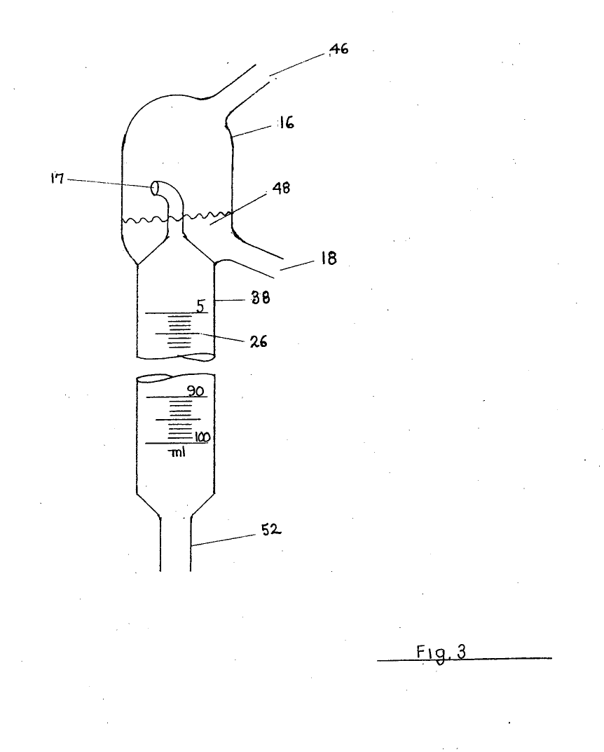

Referring to FIGS. 1 and 3 and 4, a typical Volumetric Measuring Buret 38 with automatic zero overflow configuration is illustrated. There are many shapes, sizes, configurations, volumes possible, all using the same overflow concept to achieve a constant “0” (zero), or starting point for any volume delivered from the device. Volumetric calibrations 26 on the body of the buret or device, are measured from the volume when liquid is filled to the upper end of the overflow tip 17. In the example used for the present invention, fuel is filled from the bulk container through the Flow Control Valve 33 in the “FILL” position 53 and associated connectors 30, 29, and 27, and associated conduits 31 and 28, flowing under vacuum pressure until fuel overflows the overflow tip 17. The Flow Control Valve 33 is moved to the “STOP” position 55. When operator has determined the volume of that particular fuel needed for a specified blend, the Flow Control Valve 33 is moved to the “DISPENSE” position 54, and operator may allow fuel to exit through the delivery tip 34 until the meniscus of fuel level reaches the exact volume calibrated on the device 26.

For simplicity FIG. 1 illustrates the System of the present invention with only one station to handle only one fuel. In actual practice of typical fuel blending procedures, several stations are arranged in parallel configuration, and use the extra ports represented variously by 4, and 7 of the common Vacuum Manifold 3 and Vacuum Release Manifold 6, to operate other stations to handle other fuels needed for the prescribed blend of fuels. A common arrangement is four stations handling four different fuels, but any number of stations may be operated.

It should be understood that the present invention is not limited to the exact details or embodiments shown and described, as obvious modifications and equivalents will be apparent to one skilled in the art. Accordingly, the present invention is therefore to be limited only by the scope of the appended claims.

1. A fluid (liquid) handling system for use with a variety of liquids or fluids, including petroleum octane test standard motor fuels, comprising:
an integral or external source of vacuum (reduced pressure) capable of providing sufficient force as to perform certain transfers of fluids.
a flow control valve of a configuration that will allow liquids to be directed in at least two flow paths depending on the valve's two or more positions.
a volumetric measuring device which has the function and capability of accurately containing and measuring liquid volumes dispensed therefrom.
an automatic overflow device which may be independent or integrated within the volumetric measuring device, whereby the upper filled end of a liquid column terminates in an overflow chamber or reservoir, so that excess fluid is removed, and the liquid column height and volume are always constant when the column is completely filled.
a vacuum control valve which will close automatically upon exposure to vacuum force (suction), and open automatically to atmospheric pressure when vacuum is removed.
a vacuum trap located in the vacuum source line to prevent liquids from entering the vacuum line or pump.
conduits, fittings, connectors, and other means for connection of the components comprising the fluid (liquid) handling system, in the order necessary to accomplish intended liquid transfer, measurement, and dispensing in known calibrated volumes.

2. The liquid (fluid) handling system of claim 1 that may be employed to transfer liquids or fluids from their original containers into a volumetric measuring device, and therefrom dispensed in accurate volumes, with any liquid residue in the volumetric measuring device, being returned to original container.

3. The liquid (fluid) handling system of claim 1 that may be employed to blend motor fuel standards for octane determination, by transferring one or more fuel standards from their original containers into one or more volumetric measuring devices, and therefrom dispensing various volumes required for one or more blends of fuels; and the return of any unused liquid in the volumetric measuring device back to original containers

4. The liquid (fluid) handling system of claim 1 that operates on forces of vacuum (reduced pressure), and avoids the use of electrical spark producing devices in the presence of combustible fuels and vapors.

5. The liquid (fluid) handling system of claim 1 used as a single station, or used in multiple parallel stations which employ a common vacuum (reduced pressure) source, a common vacuum pressure control valve, connecting manifolds, cabinetry, and hardware.
